(19) United States
(12) Patent Application Publication
(10) Pub. No.: US 2024/0077512 A1
(43) Pub. Date: Mar. 7, 2024

(54) SENSOR ASSEMBLY

(71) Applicant: Robert Bosch GmbH, Stuttgart (DE)

(72) Inventor: Cristian Nagel, Reutlingen (DE)

(21) Appl. No.: 18/364,050

(22) Filed: Aug. 2, 2023

(30) Foreign Application Priority Data
Sep. 1, 2022 (DE) 10 2022 209 079.9

(51) Int. Cl. G01P 15/08

(52) U.S. Cl. CPC G01P 15/0802; G01P 15/125

(57) ABSTRACT

A sensor assembly. The sensor assembly has a substrate, a seismic mass, and a functional layer arranged between the substrate and the seismic mass. The seismic mass is connected to the substrate in such a way that the seismic mass can be deflected at least along a first direction running perpendicular to the substrate. Within the functional layer and between the seismic mass and the substrate, at least one stop is formed that is spring-loaded and can be deflected along the first direction.

### CROSS REFERENCE

The present application claims the benefit under 35 U.S.C. § 119 of German Patent Application No. DE 10 2022 209 079.9 filed on Sep. 1, 2022, which is expressly incorporated herein by reference in its entirety.

### FIELD

The present invention relates to a sensor assembly.

### BACKGROUND INFORMATION

Micromechanical inertial sensors for measuring acceleration and yaw rate are mass-produced for various applications in the automotive and consumer sectors. For capacitive accelerometers with a detection direction perpendicular to the wafer plane (z-direction), rockers are preferably used. The sensor principle of such accelerometers is based on a spring-mass system, in which a movable seismic mass forms plate capacitors with, for example, two counter-electrodes fixed on the substrate along with two counter-electrodes standing in the rocker structure. The seismic mass is connected to the wafer via at least one spring element and is mounted so that it can be deflected about an axis of rotation. Due to an asymmetric mass distribution of the rocker with respect to the axis of rotation, a rotation of the rocker about the axis of rotation occurs when an acceleration along the z-direction is applied. Thus, a distance between the rocker and the counter-electrodes becomes smaller on the side with the larger mass and larger on the side with the smaller mass. The resulting change in capacitance of the plate capacitors is a measure of the applied acceleration.

Such accelerometers can be damaged at increased accelerations and by high impact energies. Thereby, in addition to mechanical defects, such as the occurrence of fractures and fracture parts and/or fracture particles, increased adhesion of the rocker to the wafer can also occur, which impedes the operation of the accelerometer.

### SUMMARY

One object of the present invention is to provide an improved sensor assembly. This object may be achieved by a sensor assembly having features of the present invention. Advantageous embodiments and developments of the present invention are disclosed herein.

According to an example embodiment of the present invention, a sensor assembly has a substrate, a seismic mass and a functional layer arranged between the substrate and the seismic mass. The seismic mass is connected to the substrate in such a way that the seismic mass is can be deflected at least along a first direction running perpendicular to the substrate. Within the functional layer and between the seismic mass and the substrate, at least one stop is formed that is spring-loaded and can be deflected along the first direction.

Advantageously, increased accelerations and high impact energies of the seismic mass can be damped and reduced by the spring-loaded stop. If the seismic mass is accelerated in the direction of the substrate in such a way that it is deflected as far as the spring-loaded stop, force is transmitted to the spring-loaded stop, causing it to deflect and absorb the energy of the movement of the seismic mass. This can prevent damage to the sensor assembly and/or sticking of the seismic mass to the substrate. The design of the spring-loaded stop is particularly small compared to conventional solutions and enables higher performance with the same size.

According to an example embodiment of the present invention, the spring-loaded stop is formed within the functional layer. In other words, the functional layer has been exposed in the region of the spring-loaded stop and is thus formed to be free-standing and flexible and can be deflected along the first direction. The spring-loaded stop can advantageously be formed with different stiffnesses, in order to be able to cushion different accelerations of the seismic mass.

In one embodiment of the present invention, an intermediate layer is arranged on a lower side of the seismic mass. The functional layer is arranged on a side of the intermediate layer facing the substrate. The functional layer is free-standing in the region of the spring-loaded stop. In other words, the intermediate layer is structured in such a way that it has been removed in the region of the spring-loaded stop, by which the spring-loaded stop is free-standing and flexible. In this embodiment, the functional layer is rigidly connected to the seismic mass and moves along with the seismic mass in the event of acceleration of the seismic mass. The connection of the functional layer to the seismic mass is ensured by the intermediate layer. The intermediate layer can have an oxide, for example. However, it is not necessarily required that the functional layer be connected to the seismic mass.

In an alternative embodiment of the present invention, an intermediate layer is arranged on an upper side of the substrate. The functional layer is arranged on an upper side of the intermediate layer facing away from the substrate. The functional layer is free-standing in the region of the spring-loaded stop. In this case, the functional layer is thus rigidly connected to the substrate and, in the event of an acceleration of the seismic mass, does not move along with said mass.

In one embodiment of the sensor assembly of the present invention, the seismic mass is formed as a rocker. The rocker is connected to the substrate via at least one spring element in such a way that the rocker is mounted so that it can be deflected about an axis of rotation running parallel to the substrate. The rocker has a frame on one side of the axis of rotation. On a side of the axis of rotation opposite the frame, the rocker has a mass element, as a result of which the rocker has an asymmetrical mass distribution with respect to the axis of rotation. However, the seismic mass does not necessarily have to be formed as a rocker. All that is required is that the seismic mass be mounted so that it can be deflected along the first direction. For this reason, the sensor assembly can also be formed differently and not be based on a rocker principle.

For example, in a simple variant, it can be sufficient for the seismic mass to be a cantilever spring deflectable along the first direction.

In one embodiment of the present invention, the spring-loaded stop is arranged in an edge region of the rocker that runs parallel to the axis of rotation. With conventional sensor assemblies without a spring-loaded stop, it is the edge region of the rocker that can strike the substrate when high or sudden strong accelerations are applied. Advantageously, the spring-loaded stop can cushion the rocker more efficiently due to its arrangement in the edge region of the rocker than if the spring-loaded stop were arranged in a central region of the rocker, for example.

In one embodiment of the present invention, the spring-loaded stop is arranged in the region of the frame of the rocker.

Advantageously, this protects in particular the frame of the rocker, which can be more fragile than the mass element of the rocker. However, in another embodiment, the spring-loaded stop can also be arranged in the region of the mass element. Higher forces act in the region of the mass element than in the region of the frame. Therefore, the arrangement of the spring-loaded stop in the region of the mass element offers the advantage that particularly high force effects on the sensor assembly may be reduced and avoided. In another variant, a spring-loaded stop is arranged in the region of the frame and a spring-loaded stop is arranged in the region of the mass element, as a result of which the rocker can be cushioned on both sides of the axis of rotation.

In one embodiment of the present invention, if the spring-loaded stop is arranged in the region of the frame, the frame can have a first thickness dimensioned parallel to the substrate in the region above the spring-loaded stop and a second thickness dimensioned parallel to the substrate in regions outside the spring-loaded stop. The first thickness is greater than the second thickness. Advantageously, the frame thereby has increased robustness in the region of the spring-loaded stop.

In one embodiment of the present invention, a first stop knob is arranged on a lower side of the seismic mass facing the spring-loaded stop, and above the spring-loaded stop. Advantageously, a maximum deflection of the seismic mass along the first direction can be reduced by the first stop knob. The maximum deflection of the seismic mass is substantially reduced by a thickness of the first stop knob. Another advantage is that the seismic mass cannot strike the spring-loaded stop directly, since only the first stop knob can come into direct contact with the spring-loaded stop, as a result of which the seismic mass can be additionally protected. For example, a particularly soft first stop knob can be used.

In one embodiment of the present invention, a second stop knob is arranged on a lower side of the spring-loaded stop facing the substrate. Advantageously, this improves the robustness of the spring-loaded stop by limiting a maximum deflection of the spring-loaded stop, namely substantially by a thickness of the second stop knob. This reduces the maximum possible tension on the spring-loaded stop, as a result of which overloading of the spring-loaded stop can be prevented. In addition, the second stop knob can be formed to be particularly soft to ensure even gentler cushioning of the seismic mass.

In another embodiment of the present invention, a third stop knob is arranged on an upper side of the spring-loaded stop facing the seismic mass. The third stop knob is an alternative to the first stop knob. In another embodiment, a fourth stop knob is arranged on an upper side of the substrate facing the spring-loaded stop. The fourth stop knob is an alternative to the second stop knob.

Due to a small area requirement, it is furthermore possible to realize a cascade of spring-loaded stops, each with a different stiffness, with each cascade stage covering an effective acceleration range. In one embodiment of the present invention, the sensor assembly has at least one further spring-loaded stop formed within the functional layer. The spring-loaded stop and the further spring-loaded stop form a first cascade of spring-loaded stops.

In one embodiment of the present invention, the sensor assembly has an additional functional layer arranged between the substrate and the seismic mass. At least one additional spring-loaded stop is formed within the additional functional layer. The spring-loaded stop and the additional spring-loaded stop are arranged one above the other and form a second cascade of spring-loaded stops.

The sensor assembly is described in detail below in connection with the figures.

### BRIEF DESCRIPTION OF THE DRAWINGS

FIG. 1 shows a sensor assembly in a perspective view, according to an example embodiment of the present invention.

FIG. 2 shows the sensor assembly of FIG. 1 in top views and in sectional views.

FIG. 3 shows a sensor assembly according to a further embodiment of the present invention in top views and in a sectional view.

FIG. 4 shows a sensor assembly according to a further embodiment of the present invention in a top view and in a sectional view.

FIG. 5 shows a sensor assembly according to a further embodiment of the present invention in a sectional view.

### DETAILED DESCRIPTION OF EXAMPLE EMBODIMENTS

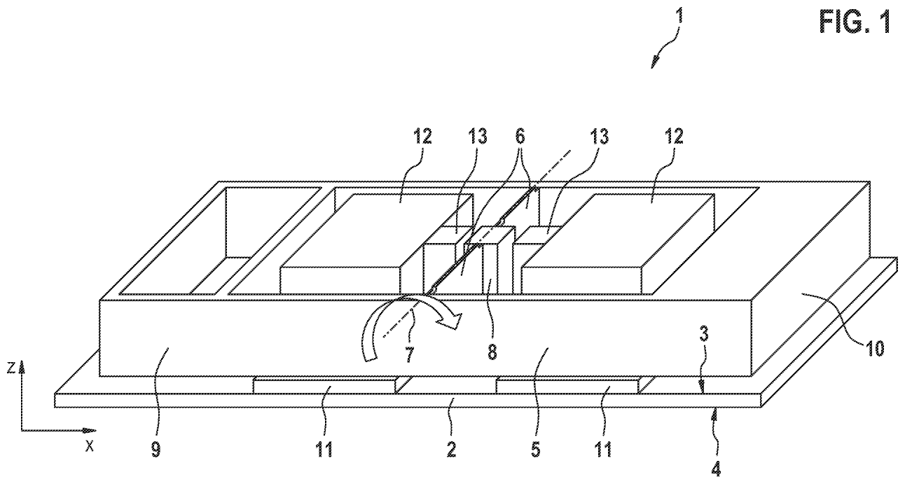

FIG. 1 schematically shows a sensor assembly 1 in a perspective view. The sensor assembly 1 is formed as an accelerometer. The sensor assembly 1 can also be referred to as a microelectromechanical (MEMS) device.

The sensor assembly 1 has a substrate 2 with an upper side 3 and a lower side 4 opposite the upper side 3. A first direction running perpendicular to the substrate 2 shall be referred to as the z-direction. The substrate 2 extends within an xy-plane perpendicular to the z-direction. The substrate 2 comprises silicon by way of example. The substrate 2 can be formed as a silicon wafer, for example. However, the substrate 2 can comprise a different material or combination of materials.

The sensor assembly 1 further has a seismic mass 5 arranged above the upper side 3 of the substrate 2. The seismic mass 5 comprises silicon by way of example. For example, the silicon of the seismic mass 5 can be deposited over the substrate 2 by epitaxial growth. A wide variety of structuring methods can be used to form the seismic mass 5. The seismic mass 5 can also be formed by a plurality of layers. In addition to silicon, other materials may be used to produce the seismic mass 5.

The seismic mass 5 is connected to the substrate 2 in such a way that the seismic mass 5 can be deflected at least along the z-direction. In the exemplary illustration, the seismic mass 5 is formed as a rocker 5. The rocker 5 is connected to the substrate 2 via two spring elements 6 in such a way that the rocker 5 is mounted so that it can be deflected about an axis of rotation 7 running parallel to the substrate 2. The axis of rotation 7 runs parallel to a second direction perpendicular to the z-direction, which shall be referred to as the y-direction, and perpendicular to a third direction perpendicular to the z-direction and the y-direction, which shall be referred to as the x-direction. The spring elements 6 are formed by way of example as torsion springs. Depending on the rocker design, one spring element 6 can also be sufficient. The at least one spring element 6 does not necessarily have to be formed as a torsion spring. The spring elements 6 are each connected to the substrate 2 via a common anchor 8, which is arranged on the upper side 3 of the substrate 2. The spring elements 6 are each connected to the anchor 8 at ends facing one another. At opposite ends of the spring elements 6, the spring elements 6 are each connected to the rocker 5. Both the spring elements 6 and the anchor 8 may comprise, for example, silicon or silicon oxide or other materials or a combination of materials, and each may be produced, for example, by structuring.

The rocker 5 has a frame 9 on one side of the axis of rotation 7. The rocker 5 has a mass element 10 on a side of the axis of rotation 7 opposite the frame 9. As a result, the rocker 5 has an asymmetrical mass distribution with respect to the axis of rotation 7. When an acceleration is applied in the z-direction, this causes the rocker 5 to rotate about the axis of rotation 7. The spring elements 6 of the sensor assembly 1, which are formed as torsion springs, run along the axis of rotation 7, since they twist in a dihedral manner when an acceleration is applied to the sensor assembly 1.

In the exemplary embodiment of the sensor assembly 1 of FIG. 1, the sensor assembly has a total of four electrically conductive electrodes 11, 12, each of which forms capacitors in sections with the seismic mass 5. Two first electrodes 11 are arranged on the upper side 3 of the substrate 2 and on opposite sides of the axis of rotation 7. Two second electrodes 12 are arranged on opposite sides of the axis of rotation 7 and are each rigidly connected to the substrate 2. The second electrodes 12 are each rigidly connected to the substrate 2 via further anchors 13, which are arranged on the upper side 3 of the substrate 2. Thus, the first electrodes 11 and the second electrodes 12 are each immovable.

In the event of an acceleration acting on the sensor assembly 1 and a resulting deflection of the seismic mass 5, distances between the electrodes 11, 12 and the seismic mass 5 change, as a result of which capacitances of the capacitors formed between the electrodes 11, 12 and the seismic mass 5 change. The changes in capacitance can be used as a measurement signal to determine the acceleration acting along the z-direction, wherein differential measurement can also be used. The sensor assembly 1 can also have a different number of electrodes 11, 12. For example, it can be sufficient for the sensor assembly 1 to have only one electrode 11, 12. However, two, three or more than four electrodes 11, 12 may also be provided.

In the event of high or sudden accelerations, the sensor assembly 1 may be damaged. In addition, the seismic mass 5 may adhere to the substrate 2 if no countermeasures are taken. The sensor assembly 1 is based on the idea of overcoming such problems.

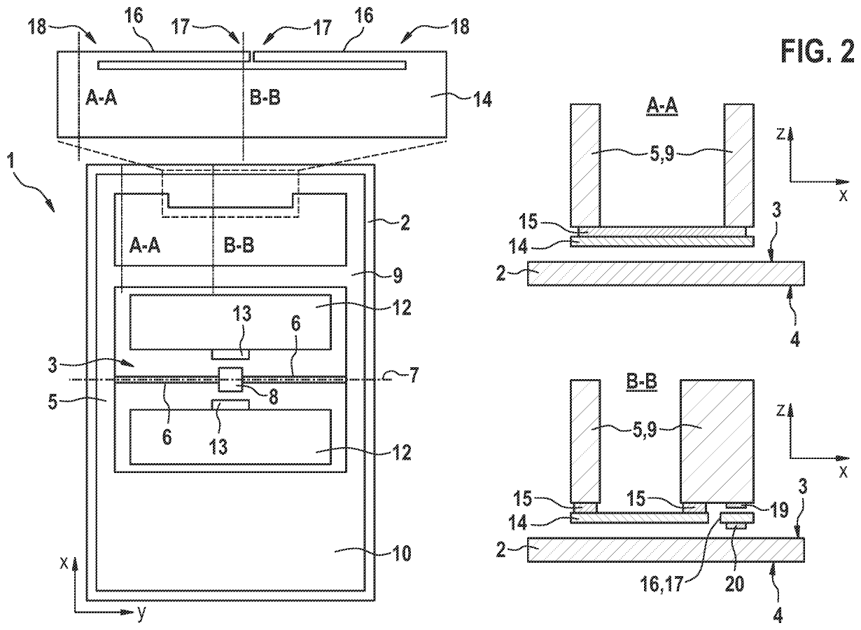

FIG. 2 schematically shows the sensor assembly 1 of FIG. 1 in a top view with a magnification according to a marked region. In addition, FIG. 2 shows the sensor assembly 1 in two different sectional views along sectional planes A-A and B-B respectively marked in the top view. The previously used reference signs are retained in the following. For the sake of simplicity, the first electrodes 11 are not shown in FIG. 2.

The sensor assembly 1 has a functional layer 14. The functional layer 4 is arranged between the substrate 2 and the seismic mass 5. In the exemplary embodiment of FIG. 2, the functional layer 14 is arranged on a lower side of the seismic mass 5 facing the substrate 2, but the functional layer 14 is not arranged directly on the seismic mass 5. Rather, any number of layers may be arranged between the seismic mass 5 and the functional layer 14. By way of example, FIG. 2 shows that an intermediate layer is arranged between the seismic mass 5 and the functional layer 14. The intermediate layer 15 is formed by way of example as an oxide layer and comprises for example silicon oxide, but it can also comprise another oxide or another material. Instead of one intermediate layer 15, a plurality of intermediate layers may also be provided.

In the exemplary embodiment, the functional layer 14 comprises polycrystalline silicon. However, the functional layer 14 can also comprise silicon of a different crystallinity or a different material. The functional layer 14 and the intermediate layer 15 along with, if necessary, other layers of the sensor assembly 1 can be deposited by means of conventional techniques, for example by means of vapor deposition. Intermediate layers 15 may also be produced, for example, by oxidation after deposition.

Since the functional layer 14 in the embodiment shown is rigidly connected to the seismic mass 5 by the intermediate layer 15, it moves with the seismic mass 5 if said mass accelerates. In an alternative embodiment, the intermediate layer 15 is arranged on the upper side 3 of the substrate 2. In this case, the functional layer 14 is arranged on an upper side of the intermediate layer 15 facing away from the substrate 2. The functional layer 14 may cover only part of the upper side 3 of the substrate 2; for example, it can be sufficient if the functional layer 14 is arranged on only one side of the axis of rotation 7. The functional layer 14 is rigidly connected to the substrate 2 at least in sections via the intermediate layer 15.

In this embodiment, which is not shown, the functional layer 14 does not move with the seismic mass 5 when it accelerates.

It can be seen from the cross-sectional views of FIG. 2 that the seismic mass 5 could strike the functional layer 14 at high accelerations, which could damage the sensor assembly 1 or cause the seismic mass 5 to adhere to the substrate 2 if no countermeasures are taken.

Within the functional layer 14 and in a region between the seismic mass 5 and the substrate 2, at least one stop 16 is formed that is spring-loaded. The spring-loaded stop 16 can be deflected along the z-direction. In the exemplary embodiment of the sensor assembly of FIG. 2, the functional layer 14 has a total of two spring-loaded stops 16. The functional layer 14 is exposed in the region of the spring-loaded stops 16 in each case; i.e., in the region of the spring-loaded stops 16, no intermediate layers 15 are arranged between the functional layer 14 and the seismic mass 5 or the substrate 2, which can be seen in the cross-sectional view along the plane B-B along a spring-loaded stop 16. This can be achieved, for example, by depositing the functional layer 14 on the intermediate layer 15, structuring the functional layer 14 in such a way that the spring-loaded stops 16 are formed and subsequently removing the intermediate layer 15 in regions below the spring-loaded stops 16.

The spring-loaded stops 16 are formed for example as cantilever springs. Thus, the spring-loaded stops 16 in each case have a free end 17 and a fixed end 18. In the region of the fixed ends 18, the spring-loaded stops 16 are each rigidly connected to the functional layer 14. The magnification in FIG. 2 shows that the spring-loaded stops 16 are arranged to run parallel to the axis of rotation 7 for example, although this is not absolutely necessary. In the magnification in FIG. 2, the seismic mass 5 is not shown, in order to be able to recognize the functional layer 14. The free ends 17 of the spring-loaded stops 16 are arranged facing one another. The fixed ends 18 of the spring-loaded stops 16 are arranged on opposite sides of the spring-loaded stops 16. This arrangement means that the free ends 17 of the spring-loaded stops 16 are each arranged in the edge region of the rocker 5, as a result of which the rocker 5 can be cushioned particularly effectively. However, this arrangement of the spring-loaded stops 16 is merely by way of example. The spring-loaded stops 16 may also be arranged and oriented differently than shown in FIG. 2. The spring-loaded stops 16 may also have other geometric shapes.

The spring-loaded stops 16 are provided to cushion the seismic mass 5 in the event of high acceleration forces acting on the seismic mass 5 and causing excessive deflection of the seismic mass 5, in order to protect the sensor assembly 1 from damage. By limiting a maximum deflection of the seismic mass 5 by the spring-loaded stops 16, adhesion of the seismic mass 5 to the substrate 2 can also be prevented. A stiffness of the spring-loaded stops 16 can be influenced, for example, by a specific choice of a material of the functional layer 14, its crystallinity, a thickness of the functional layer 14, a length of the spring-loaded stops 16 and their geometric shapes.

In the exemplary variant of the sensor assembly 1 of FIG. 2, in which the seismic mass 5 is formed as a rocker 5, it is expedient to arrange the at least one spring-loaded stop 16 in an edge region of the rocker 5 running parallel to the axis of rotation 7, since it is in particular this edge region of the rocker 5 that could come into contact with the functional layer 14 in the event of excessive acceleration.

Furthermore, in the exemplary embodiment of the sensor assembly 1 of FIG. 2, the spring-loaded stops 16 are each arranged in the region of the frame 9 of the rocker 5, i.e. in each case in a region between the substrate 2 and the frame 9 of the rocker 5. This cushions and protects in particular the more fragile frame 9 in the event of high accelerations. However, the at least one spring-loaded stop 16 does not necessarily have to be arranged in the region of the frame 9 of the rocker 5. Instead, it can also be arranged in the region of the mass element 10 of the rocker 5. This allows the rocker 5 to be cushioned and protected, in particular in the region of particularly high acceleration forces. There can also be at least one spring-loaded stop 16 arranged in the region of the frame 9 and at least one spring-loaded stop 16 arranged in the region of the mass element 10, as a result of which the rocker 5 can be cushioned on both sides of the axis of rotation 7. It is further expedient that the frame 9 is reinforced in the region above the at least one spring-loaded stop 16, i.e. that the frame 9 has a first thickness dimensioned parallel to the substrate 2 in the region above the spring-loaded stop 16 and a second thickness dimensioned parallel to the substrate 2 in regions outside the spring-loaded stop 16, wherein the first thickness is greater than the second thickness. However, the frame 9 does not necessarily have to be reinforced in the region of the spring-loaded stop 16, as shown in FIG. 2.

In order to limit a maximum deflection of the seismic mass 5 or the rocker 5, a first stop knob 19 is arranged on a lower side of the seismic mass 5 facing the at least one spring-loaded stop 16, and above the spring-loaded stop 16. This can be seen in FIG. 2 in the cross-sectional view along the plane B-B. The first stop knob 19 comprises silicon by way of example, but it can also comprise another material; in particular, the first stop knob 19 can comprise an elastic material, for example an elastomer, to provide additional damping in the event of striking by the seismic mass 5.

In addition, a second stop knob 20 is arranged on a lower side of the spring-loaded stop 16 facing the substrate 2. The second stop knob 20 can additionally limit the maximum deflection of the seismic mass 5 and have a damping effect. The second stop knob 20 also comprises silicon, for example, but it can also comprise another material, in particular an elastic material, for example. The first and second stop knobs 19, 20 are preferably arranged in the region of the free end 17 of the at least one spring-loaded stop 16, although this is not absolutely necessary. Depending on the position of the stop knobs 19, 20, the deflection of the seismic mass 5 and of the at least one spring-loaded stop 16 can be influenced differently.

The first stop knob 19 and the second stop knob 20 can each be formed by structuring a layer arranged on the lower side of the functional layer 14 or can be arranged on the lower side of the functional layer 14 facing the substrate 2, for example by bonding the stop knobs 19, 20. The first stop knob 19 and the second stop knob 20 can either individually or both be omitted.

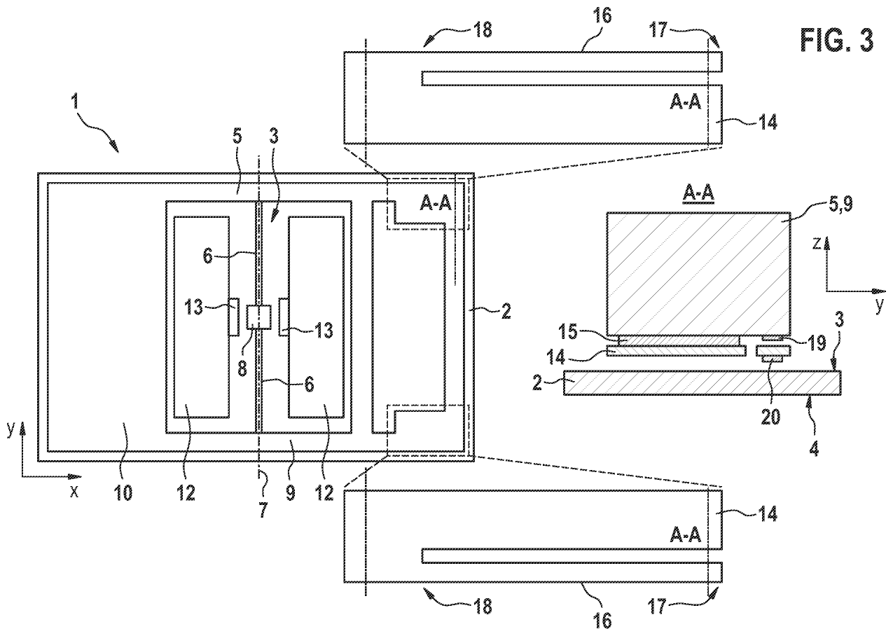

FIG. 3 schematically shows a sensor assembly 1 according to a further embodiment in a top view with two magnifications according to respectively marked regions. In addition, FIG. 3 shows the sensor assembly 1 in a sectional view along a sectional plane A-A marked in the top view. The sensor assemblies 1 of FIG. 2 and FIG. 3 have great similarities. The reference signs used so far are retained in the following for similar or identically formed elements. In the following, only the differences between the sensor assembly 1 of FIG. 3 and the sensor assembly 1 of FIG. 2 are described. For the sake of simplicity, the first electrodes 11 are not shown in FIG. 3.

In the sensor assembly 1 of FIG. 2, the spring-loaded stops 16 are each arranged to run perpendicular to the axis of rotation 7, wherein the free ends 17 of the spring-loaded stops 16 are each arranged facing away from the spring elements 6, so that the rocker 5 can come into contact with the spring-loaded stops 16 with its edge region in each case in the region of the free ends 17 of the spring-loaded stops 16. The spring-loaded stops 16 are further arranged in corner regions of the frame 9, as a result of which the spring-loaded effect is evenly distributed over the seismic mass 5.

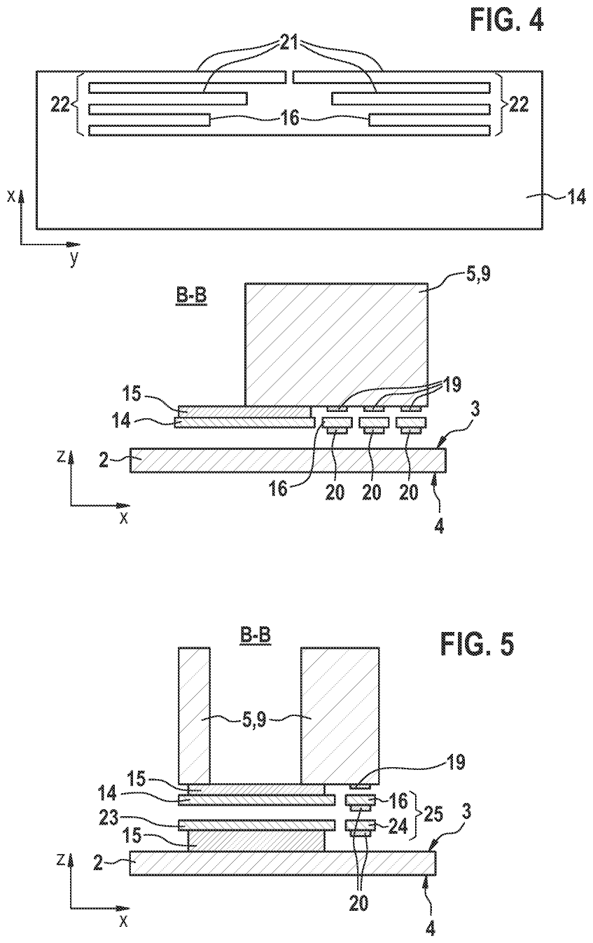

FIG. 4 shows a part of a sensor assembly 1 according to a further embodiment in a cross-sectional view according to the sectional view B-B of FIG. 2, and a part of the functional layer 14 in a top view. The sensor assemblies 1 of FIG. 2 and FIG. 4 have great similarities. The reference signs used so far are retained in the following for similar or identically formed elements. In the following, only the differences between the sensor assembly 1 of FIG. 4 and the sensor assembly 1 of FIG. 2 are described.

The sensor assembly 1 of FIG. 4 has at least one further spring-loaded stop 21 formed within the functional layer 14. By way of example, four further spring-loaded stops 21 are formed in the functional layer 14 in addition to the two spring-loaded stops 16. Like the spring-loaded stops 16, the further spring-loaded stops 21 are formed as cantilever springs. The further spring-loaded stops 21 are arranged parallel to the spring-loaded stops 16 and run parallel to the axis of rotation 7, i.e. parallel to the y-direction. In each case, one spring-loaded stop 16 and two further spring-loaded stops 21 or the at least one further spring-loaded stop 21 form a first cascade 22 of spring-loaded stops 16, 21. Within a first cascade 22, the spring-loaded stops 16 and further spring-loaded stops 21 are arranged laterally beside one another in the x-direction.

The spring-loaded stops 16, 21 of a first cascade 22 each have different lengths. As a result, the spring-loaded stops 16, 21 have different spring constants. By way of example, the length of the spring-loaded stops 16, 21 increases with increasing distance from the axis of rotation 7. As the length increases, a stiffness of the spring-loaded stops 16, 21 decreases. In this way, each spring-loaded stop 16, 21 covers different acceleration value ranges within which it can cushion the seismic mass 5 or the rocker 5, as a result of which cascaded cushioning of the seismic mass 5 can take place.

The sensor assembly 1 of FIG. 4 is based on the sensor assembly 1 of FIG. 2, in which the spring-loaded stops 16 are arranged to run parallel to the y-direction. However, the sensor assembly 1 of FIG. 4 can also be based on the sensor assembly 1 of FIG. 3, in which the spring-loaded stops 16 are arranged to run parallel to the x-direction. In this case as well, a first cascade 22 of spring-loaded stops 16 formed within the functional layer 14 and further spring-loaded stops 21 can be formed, which in this case are arranged one behind the other in the y-direction and have different lengths in order to provide cascaded cushioning.

Only by way of example does FIG. 4 show that a first and second stop knob 19, 20 are provided for each spring-loaded stop 16 and for each further spring-loaded stop 21, but this is not absolutely necessary in each case.

FIG. 5 shows a part of a sensor assembly 1 according to a further embodiment in a cross-sectional view according to the sectional view B-B of FIG. 2. The sensor assemblies 1 of FIG. 2 and FIG. 5 have great similarities. The reference signs used so far are retained in the following for similar or identically formed elements. In the following, only the differences between the sensor assembly 1 of FIG. 5 and the sensor assembly 1 of FIG. 2 are described. In FIG. 5, it is shown by way of example that a second stop knob 20 is arranged on a lower side of the additional spring-loaded stop 24, but this can also be omitted.

The sensor assembly 1 according to FIG. 5 has an additional functional layer 23 arranged between the substrate 2 and the seismic mass 5. By way of example, the additional functional layer 23 is arranged below the functional layer 14, but it can also be arranged above the functional layer 14. Between the functional layer 14 and the seismic mass 5 and between the additional functional layer 23 and the substrate 2, an intermediate layer 15 is arranged in each case by way of example. Thus, in this embodiment, the functional layer 14 is rigidly connected to the seismic mass 5, while the additional functional layer 23 is rigidly connected to the substrate 2. Thus, only the functional layer 14 moves with the seismic mass 5 when it accelerates. In an alternative embodiment, both the functional layer 14 and the additional functional layer 23 are rigidly connected to the seismic mass 5. In this case, an additional intermediate layer 15 is arranged on a side of the functional layer 14 facing the substrate 2, and the additional functional layer 23 is arranged on a side of the additional intermediate layer 15 facing the substrate 2. In another variant, both functional layers 14, 23 are rigidly connected to the substrate 2 via the intermediate layers 15. In this case, the functional layer 14 according to FIG. 2 is connected to the substrate 2 via the intermediate layer 15. The additional intermediate layer 15 is arranged on a side of the functional layer 14 facing the seismic mass 5. The additional functional layer 23 is arranged on a side of the additional intermediate layer 15 facing the seismic mass 5.

At least one additional spring-loaded stop 24 is formed within the additional functional layer 23. By way of example, only one additional spring-loaded section 24 is formed in the additional functional layer 24. The additional spring-loaded stop 24 is arranged above the spring-loaded stop 16. The spring-loaded stop 16 and the additional spring-loaded stop 24 form a second cascade 25 of spring-loaded stops 16, 24. However, in contrast to the sensor assembly 1 of FIG. 4, cascaded cushioning of the seismic mass 5 along the z-direction takes place in the sensor assembly 1 of FIG. 5, since the spring-loaded stops 16, 21 are arranged one above the other. In this case, the spring constants of the spring-loaded stops 16, 24 can each be varied, for example, by a thickness of the functional layer 14 and a thickness of the additional functional layer 23. For example, it is expedient that the additional functional layer 23 has a greater thickness than the functional layer 14, so that it is more rigid than the functional layer 14.

First cascades 22 of spring-loaded stops 16, 21 and second cascades 25 of spring-loaded stops 16, 23 can also be combined with one another, as a result of which cascaded cushioning of the seismic mass 5 can take place in the z-direction and in the xy-plane.

What is claimed is:

1. A sensor assembly, comprising:
a substrate;
a seismic mass;
a functional layer arranged between the substrate and the seismic mass;
wherein the seismic mass is connected to the substrate in such a way that the seismic mass can be deflected at least along a first direction running perpendicular to the substrate; and
wherein, within the functional layer and between the seismic mass and the substrate, at least one stop is formed that is spring-loaded and can be deflected along the first direction.

2. The sensor assembly according to claim 1, wherein:
an intermediate layer is arranged on a lower side of the seismic mass;
the functional layer is arranged on a side of the intermediate layer facing the substrate; and
in the functional layer is free-standing in a region of the spring-loaded stop.

3. The sensor assembly according to claim 1, wherein:
an intermediate layer is arranged on an upper side of the substrate;
the functional layer is arranged on an upper side of the intermediate layer facing away from the substrate; and
the functional layer is free-standing in a region of the spring-loaded stop (16).

4. The sensor assembly according to claim 1, wherein:
the seismic mass is formed as a rocker;
the rocker is connected to the substrate via at least one spring element in such a way that the rocker is mounted so that the rocker can be deflected about an axis of rotation running parallel to the substrate;
the rocker has a frame on one side of the axis of rotation; and
the rocker has a mass element on a side of the axis of rotation opposite the frame, as a result of which the rocker has an asymmetrical mass distribution with respect to the axis of rotation.

5. The sensor assembly according to claim 4, wherein the spring-loaded stop is arranged in an edge region of the rocker running parallel to the axis of rotation.

6. The sensor assembly according to claim 4, wherein the spring-loaded stop is arranged in a region of the frame of the rocker.

7. The sensor assembly according to claim 6, wherein the frame has a first thickness dimensioned parallel to the substrate in the region above the spring-loaded stop and a second thickness dimensioned parallel to the substrate in regions outside the spring-loaded stop, where the first thickness is greater than the second thickness.

8. The sensor assembly according to claim 4, wherein the spring-loaded stop is arranged in a region of the mass element of the rocker.

9. The sensor assembly according to claim 1, wherein a first stop knob is arranged on a lower side of the seismic mass facing the spring-loaded stop, and above the spring-loaded stop.

10. The sensor assembly according to claim 1, wherein a second stop knob is arranged on a lower side of the spring-loaded stop facing the substrate.

11. The sensor assembly according to claim 1, further comprising:
at least one further spring-loaded stop formed within the functional layer;
wherein the spring-loaded stop and the further spring-loaded stop form a first cascade of spring-loaded stops.

12. The sensor assembly according to claim 1, comprising:
an additional functional layer arranged between the substrate and the seismic mass;
wherein at least one additional spring-loaded stop is formed within the additional functional layer, and wherein the spring-loaded stop and the additional spring-loaded stop are arranged one above the other and form a second cascade of spring-loaded stop and the at least one additional spring-loaded stop.
